(19) United States
(12) Patent Application Publication
(10) Pub. No.: US 2015/0032771 A1
(43) Pub. Date: Jan. 29, 2015

(54) SYSTEM AND METHOD FOR SHARING GEO-LOCALIZED INFORMATION IN A SOCIAL NETWORK ENVIRONMENT

(71) Applicant: Alessandro BERIO, Rio de Janeiro (BR)

(72) Inventor: Alessandro BERIO, Rio de Janeiro (BR)

(21) Appl. No.: 14/340,487

(22) Filed: Jul. 24, 2014

Related U.S. Application Data
(60) Provisional application No. 61/858,608, filed on Jul. 25, 2013.

(51) Int. Cl. G06F 17/30; H04L 12/58

(52) U.S. Cl. CPC G06F 17/30424; G06F 17/30241; H04L 51/32
USPC 707/769

(57) ABSTRACT

An augmented reality social network system is provided. The system allows social network users to capture and share emotional sentiment with other users in the system via simple one word postings or “thoughts” which may be associated as metadata with location-tagged photographs taken using a camera on a client device. Users are able to comment on these thoughts and their associated images, as well as provide emotional feedback by indicating an emotional response generated by the posted thoughts. The thoughts may be superimposed on images and may also be interactive.

### CROSS-REFERENCE TO RELATED APPLICATIONS

This application claims the benefit of U.S. Provisional Patent Application No. 61/858,608, filed Jul. 25, 2013, which is hereby incorporated by reference in its entirety.

### BACKGROUND OF THE INVENTION

1. Field of the Invention

This application relates to sharing of geo-localized information in social networking applications. More particularly, this application relates to a social networking platform which allows users to post geo-localized content, associate that contents with an emotion, sentiment, or feeling, and visualize the posted content in an augmented reality context.

2. Description of the Related Technology

In recent years the popularity of social networking platforms has increased dramatically. Websites such as Facebook, Google+, and others have garnered user account bases numbering in the millions, if not hundreds of millions. The popularity of these web sites can be explained in part because they allow users to easily and widely distribute information about themselves to people with whom they are not in close physical proximity. More recently, other types of social networking platforms have emerged, such as microblogging sites (e.g. Twitter). These new microblogging platforms are designed to allow users to post short text-based messages which are distributed to other network users who follow their account. Although these social networking platforms are effective in their abilities to efficiently share information, they suffer from certain drawbacks. For example, these social networks are primarily text-based, and are limited in their ability to provide location-based sentiment analysis of their users. Still further, existing social networking platforms also provide little, if any support, for augmented-reality services.

### SUMMARY

In one embodiment, an augmented reality social network system is provided. The system includes an accounts database having user account data associated with one or more users. The user account data may include post data, thought data, location data, and emotional profile data. The system also may include an application server configured to receive image data including image metadata, location information, an emotional sentiment value, and a thought from a client device associated with one of the users. The application server may be configured to post the image data, location information, emotional sentiment value, and a thought to a social network system account associated with the user and modify the user account data based on the posted data. The system may further include an image processing module configured to process the received image data by superimposing the received thought in the image data based on the image metadata. The image processing module may also store the processed image in the accounts database. The system may also include a mapping module configured to receive a request from a client device for information relating to a location. The mapping module may further search the accounts database for thoughts and emotional sentiment values associated with the location, and identify thoughts and emotional sentiment values associated with the location. The mapping module may be further configured to transmit map information and the identified thoughts and emotional sentiment values for display within the transmitted map information.

### BRIEF DESCRIPTION OF THE DRAWINGS

FIG. 1 is a high level system diagram showing various components of a social networking platform in accordance with one or more embodiments disclosed herein.

FIG. 2 is a more detailed view of a client device from FIG. 1.

FIGS. 3A-3C are more detailed views of various components of the client device shown in FIG. 2.

FIG. 4 is a more detailed view of various modules included in the application software shown in FIG. 3C.

FIG. 5 is a more detailed view of the social networking system shown in FIG. 1.

FIG. 6 is a more detailed view of the accounts database shown in FIG. 5.

FIG. 7 is a more detailed view of how user accounts may be stored in the accounts database of FIG. 6 according to one or more embodiments.

FIG. 8 is a flowchart showing a process by which an image and associated metadata may be uploaded to the social networking system according to one or more embodiments.

FIG. 9 is a flowchart showing a process by which previously posted user thoughts may be displayed in an augmented reality view on a client device according to one or more embodiments.

FIG. 10 is a flowchart showing a process for retrieving images to display to a user within a map on a client device based on the location of a user.

FIG. 11 is a flowchart showing a process for selecting, retrieving, and displaying thoughts in a map on a client device according to one or more embodiments.

FIG. 12 is a flowchart showing an example of a search algorithm that may retrieve data based on emotional sentiment associated with one or more users.

FIG. 13 is a flowchart showing another example of a search algorithm that may retrieve data based on emotional sentiment associated with one or more users.

FIG. 14 is a flowchart showing an example of a process by which advertisements may be delivered to a client device based on a user's location and emotional profile.

FIG. 15 is a flowchart providing an example of a process by which advertisements may be delivered to a client device for display within an augmented reality or map view.

FIGS. 16A-16D are examples of user interfaces which may be used to implement a process for commenting on a posted message within an augmented reality social networking system according to one or more embodiments.

FIG. 17A-17C are examples of user interfaces which may be used to post a visual thought within an augmented reality social networking system according to one or more embodiments.

FIGS. 18A-18C are examples of user interfaces which provide information regarding thoughts and emotional sentiment in a specified location has displayed on a map and/or within an augmented reality interface.

FIG. 19 is an example of a user interface for providing notifications to a user of the social networking system.

FIGS. 20A-20C are examples of a user interface which superimposes posted thoughts within an augmented reality view according to one or more embodiments.

### DETAILED DESCRIPTION OF CERTAIN INVENTIVE EMBODIMENTS

According to one or more embodiments, an augmented reality social networking system is provided, which allows users to capture and share emotional sentiment with other users in the system via simple one word postings or “thoughts” which may be associated as metadata with location-tagged photographs taken using a camera on a client device. Users are able to comment on these thoughts and their associated images, as well as provide emotional feedback by indicating an emotional response generated by the posted thoughts. Unlike prior social networking platforms, which limit emotional response to simply liking or not liking particular content, embodiments of the invention described herein provide for a much richer and systematized range of emotional feedback. This richer range of emotional feedback may provide significant and useful information for analysis of consumer habits, popular sentiment, and other forms of sociological study.

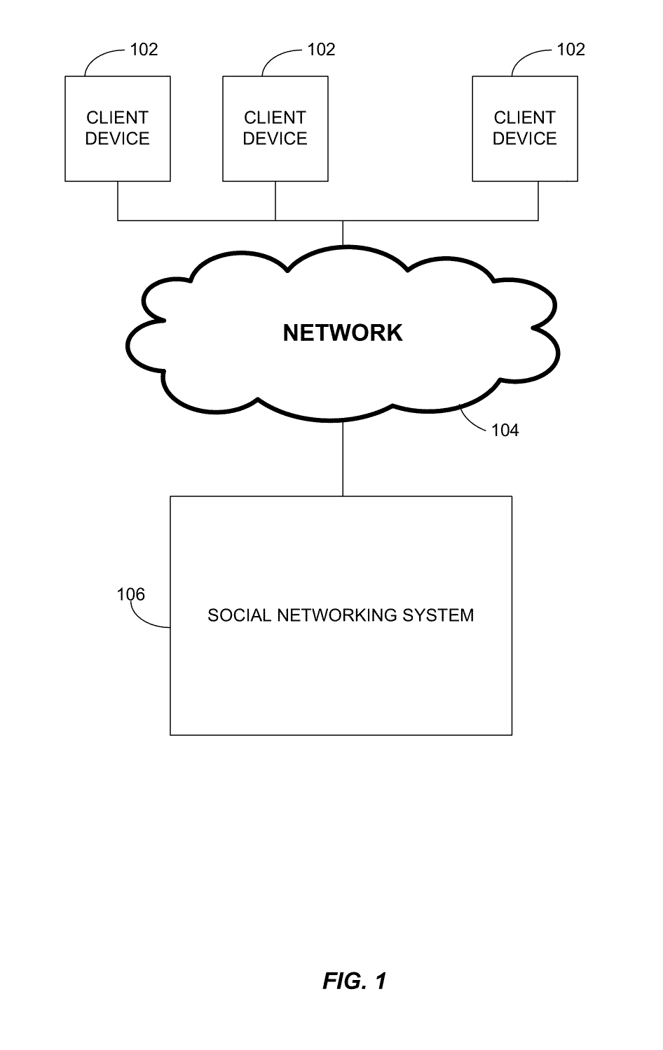

Embodiments of the invention may be implemented in a social networking platform environment. Turning to FIG. 1, a high-level view of one example of a social networking platform environment is provided. Environment may include one or more client devices 102. The client devices 102 may be a number of different types of devices. For example client device 102 may take the form of a handheld mobile phone. Alternatively, a client device 102 may be a tablet computer, a laptop computer, a desktop computer or even a wearable computing device. In general, the client device 102 may be any computing device which can connect and communicate with the social networking platform environment. The environment may also include a computer network. The computer network may take various forms. In one embodiment, the computer network is a wide area network, such as the Internet, for example. The computer network may also include a telephone network such as a mobile telephone network or a public switched telephone network. The network may also include various local area networks which are attached to the wide area network and provide local communications between various Client devices 102.

Also connected to the network may be a social networking system 106. As will be described in detail below, the social networking system 106 and may include hardware and software which is used to provide a social networking platform from which the Client devices 102 may post, view, store, and otherwise use information provided by users of the system.

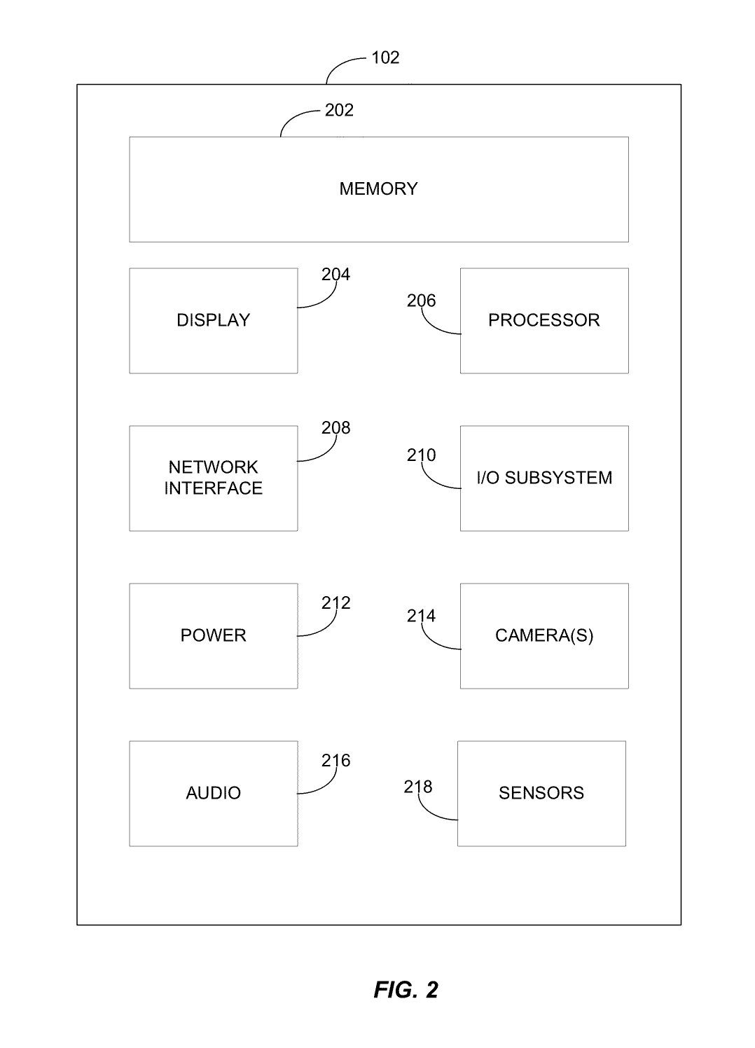

Turning now to FIG. 2, an example of a client device 102 is provided. In this particular example the client device 102 is a mobile telephone device such as an iPhone, and android device, a blackberry device, or a Windows device. The mobile telephone device may include a memory. The memory 202 may include volatile memory 202 such as some form of random access memory, and it may also include nonvolatile memory 202 such as flash memory, USB memory, or a hard disk drive, for example.

The client device 102 may also include a display. The display 204 may be a high resolution color display 204 which is suitable for displaying images such as photographic images and high-resolution graphics. In some embodiments, the display 204 may be a touchscreen 312 display. The display 204 may be generally used to provide for future access to a graphical user interface environment which allows for effective interaction with the client device 102. The client device 102 may also include a processor. The processor 206 may take various forms. In some embodiments, the processor 206 may be a mobile telephone processor 206 such as a Snapdragon processor 206 made by QUALCOMM Inc. The processor 206 may be a single-core processor, a dual-core processor, a quad-core processor, or some other multi-core processor. The process or may be a system-on-a-chip (“SOC”) processor, or it may be a dedicated central processing unit (“CPU”) processor 206 which works in conjunction with other sub processors in the system.

The client device 102 may also include a network interface. The network interface 208 may be part of the processor, or it may be a separate component which is dedicated to providing network connectivity on the client device 102. The network interface 208 may include one or more chips, and it may interface with one or more different networks. For example, the network interface 208 may provide an interface into a local area network via a Wi-Fi connection. The network interface 208 may also provide an interface to a mobile telephone network such as a 3G CDMA network or a GSM network. Depending on the type of network chip present in the client device 102, the network interface 208 may also provide access to some other type of network, such as a 4G LTE network, for example.

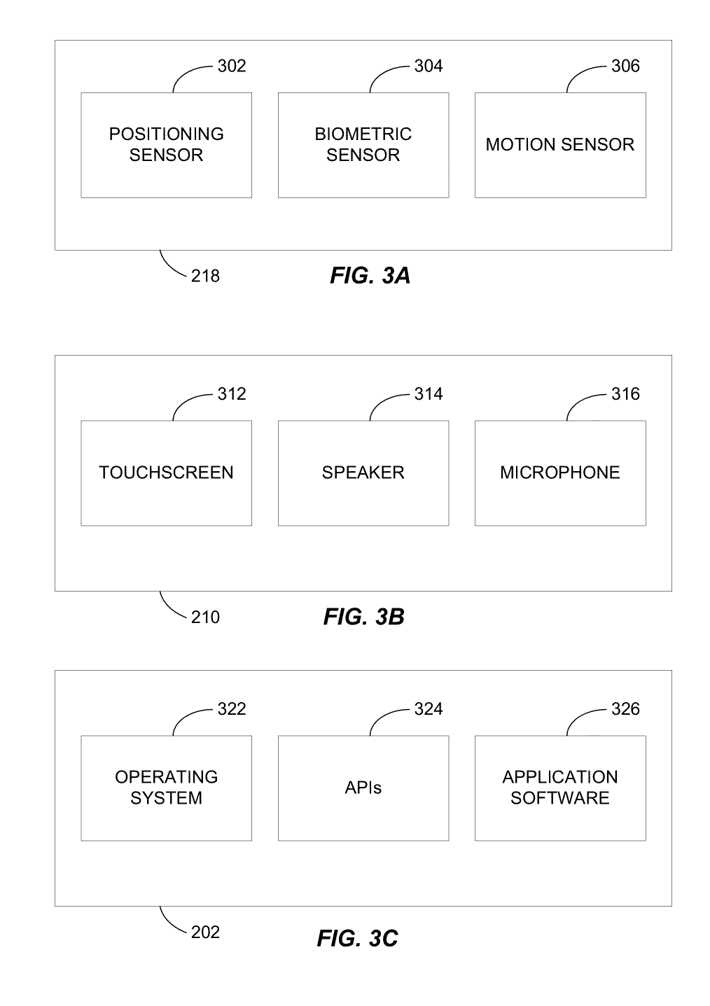

The client device 102 may also include an I/O subsystem. As will be discussed in additional detail in connection with FIG. 3B below, the I/O subsystem 210 maybe generally configured to allow for the input and output of data from the client device 102. The client device 102 also may include a power supply 212. The power supply 212 is generally used to provide power to the client device 102 so that it may be operated effectively. The power supply 212 may include a battery which stores charge sufficient to operate the device for extended periods of time when not connected to a power plug. The power supply 212 may also include a power cord which allows the device to be connected to a local electrical grid.

The client device 102 may further include one or more cameras 214. The cameras 214 may be controlled using hardware and/or software stored on the device, and may be used to take photographs which are stored digitally in the memory 202 on the device. In some embodiments, there may be both a front facing and a back facing camera on the device. As will be explained below, the front facing camera may be used to take photographs of the user of the device in order to incorporate those photographs in the social networking application disclosed herein. The client device 102 also may include an audio component 216. The audio component 216 may include a digital signal processor which digitizes sound and is used to output it to a speaker 314 or some other audio output device. The client device 102 may further include one or more sensors 218. As discussed below, the sensors 218 may be used to provide various measurements and information to software operating on the client device 102.

FIG. 3A is a more detailed view of the sensors 218 that may be included in the client device 102. The sensors 218 may include a positioning sensor 302. The positioning sensor 302 may take the form of a global positioning system (“GPS”) chip which is used to communicate with GPS satellites to determine the precise location of the client device 102. The client device 102 may also include a biometric sensor 304. The biometric sensor 304 may take various forms, but is generally used to recognize and respond to biometric characteristics of the user of the device. For example, the biometric sensor 304 may include a fingerprint reader which is used to authenticate a user to the client device 102. Alternatively, the biometric sensor 304 may be a sound detector, which uses the voice of a specific user to determine whether to allow access to certain functionality and/or operations on the client device 102. The client device 102 may also include motion sensors 306. The motion sensors may take the form of accelerometers, gyroscopes, compasses and/or a combination of each and may be generally used to detect motion and/or direction movement of the device 102.

FIG. 3B is a more detailed view of the I/O subsystem 210 from FIG. 2. The I/O subsystem 210 may include various components which are used to receive inputs and provide outputs of both text and multimedia data to users of the client device 102. The I/O subsystem 210 may include a touchscreen 312. The touchscreen 312, which may be controlled by a combination of both hardware and software, may provide a user interface which allows operations of the device to be controlled by touching specified areas on the screen. In some embodiments, the touchscreen 312 may provide an electronic keyboard which allows for input of textual commands and data into the client device 102. Also shown in FIG. 3B is a speaker 314. The speaker 314 may also be part of the I/O subsystem. The speaker 314, which may interface with the audio component described in connection with FIG. 2, may be used to provide audio output of sound to a user of the client device 102. The speaker 314 may be integral with the client device 102, or it may be a separate component is added to the device. The I/O subsystem 210 may also include a microphone 316. The microphone 316, which may be integral to the device, or a peripheral component, they generally used to receive audio input into the device. The speaker 314 and the microphone 316 together may be used to facilitate voice-enabled functionalities such as phone and voicemail functions.

FIG. 3C is a more detailed view of the memory 202 from FIG. 2. As discussed above, the memory 202 may include volatile and/or nonvolatile memory. Stored in the memory 202 may be an operating system 322. The operating system 322 may be any one of various different types of operating system 322s. For example, the operating system 322 may be the iOS operating system 322, the Android operating system 322, the BlackBerry operating system 322, Windows, HP OS, chrome OS, or the like. The operating system 322 may be generally configured to control operation of the device via commands received from the I/O subsystem. Also stored in the memory 202 may be one or more application programming interfaces 324 (“APIs”). The APIs 324 may be used to allow third-party software applications to effectively communicate with the operating system 322 and function properly on the client device 102. The memory 202 may also include application software 326. The application software 326 may be third-party software applications which are installed on the computer device, or it may be application software 326 which is shipped with the device and tightly integrated into the operating system 322. A skilled artisan will readily appreciate that the operating system 322 may include many functions additional to those described above, and it may take various different forms.

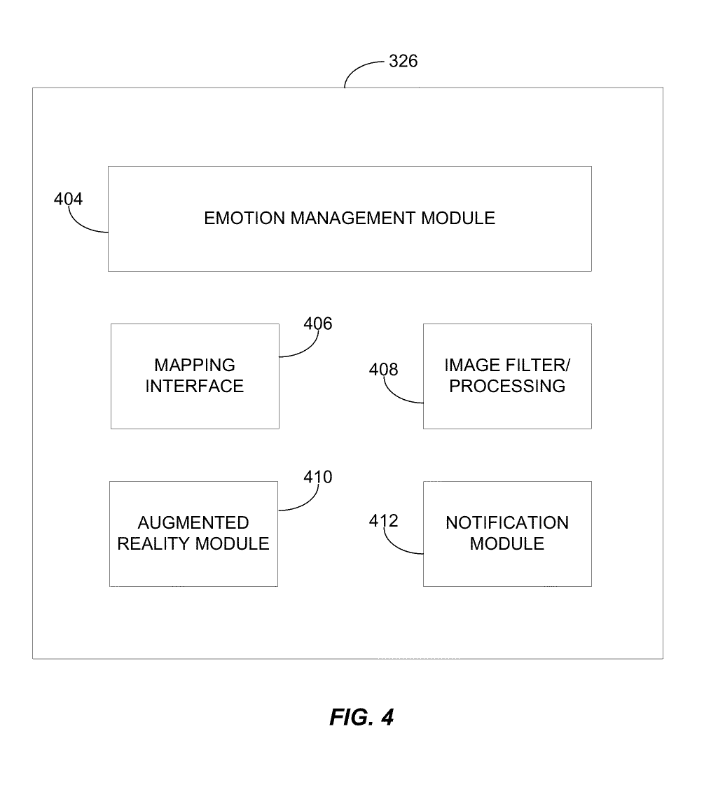

In some embodiments, the application software 326 will include client software for an augmented reality social networking client application. To this end, the application software 326 may include various modules and submodules which allow it to function within the augmented reality social networking platform. FIG. 4 provides an illustration of some of the modules which may be included within the augmented reality social networking client application. For example, the application software 326 may further include an emotion management module 404. The emotion management module 404 is a software component within the application software 326 which allows a user to define, express, manage, and illustrate emotional sentiments within the social networking system 106. In some embodiments, the emotion management module 404 allows a user to associate specific content such as photographs with specific predefined emotions. For example, a user may take a photograph of themselves with a big smile, and associate that photograph with a happy emotion. Similarly, a user may take a photograph of themselves with a frown, and associate that photograph with a sad emotion. The emotion management module may also permit users to associate emotions with specific colors. Alternatively, the system may provide predefined colors with which the motions are associated in order to ensure consistency of meaning throughout the system.

The emotion management module may also be used to allow users to post comments and private messages within the social networking system 106. These comments and/or messages may be associated with particular emotions which provide an additional layer of information about the emotional response to a post made in the social networking system 106. In some embodiments, the emotion management module may also be configured to allow users to post photographs and thoughts which are tied to an emotion. Typically, this will be done by coloring the content according to the emotional sentiment that the posting user wishes to convey. Using the emotion management module, a user is able to create content, such as short text, which may be posted along with a photograph taken using the client device 102.

The application software 326 may also include a mapping interface module 406. The mapping interface module 406 may be software which is configured to work in conjunction with the positioning sensor to display 204 maps based on the current location of the client device 102. The mapping interface module 406 may utilize APIs 324 which allow it to connect to external services or internal map databases which provide maps for display 204 on the device. The mapping interface 406 may also be configured to access and accounts database 510 stored on the social networking system 106 in order to retrieve thoughts, photographs, and other data which is associated with a particular location on the map. As will be explained in detail below, the retrieved data may be superimposed onto the map to provide a visual representation of prevailing sentiment and emotion in a particular geographic area.

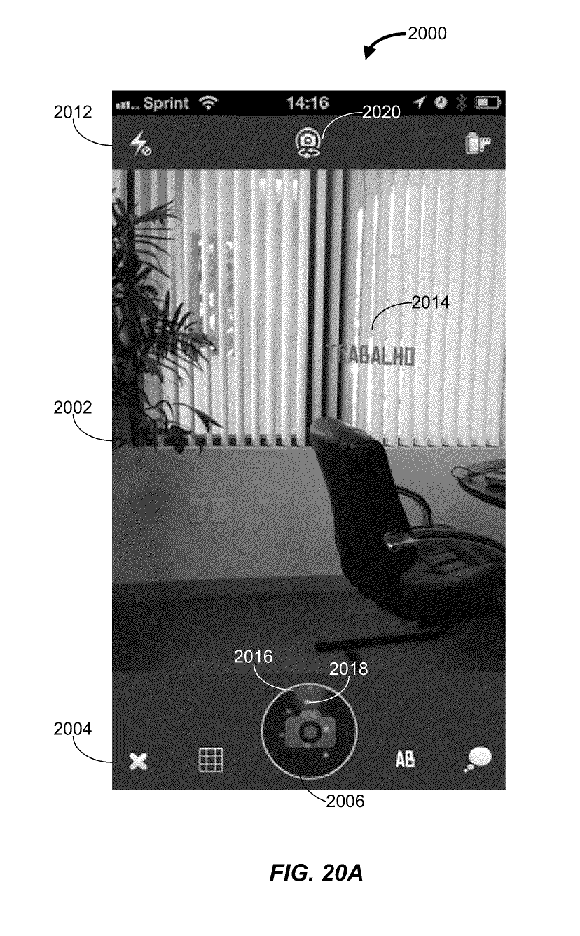

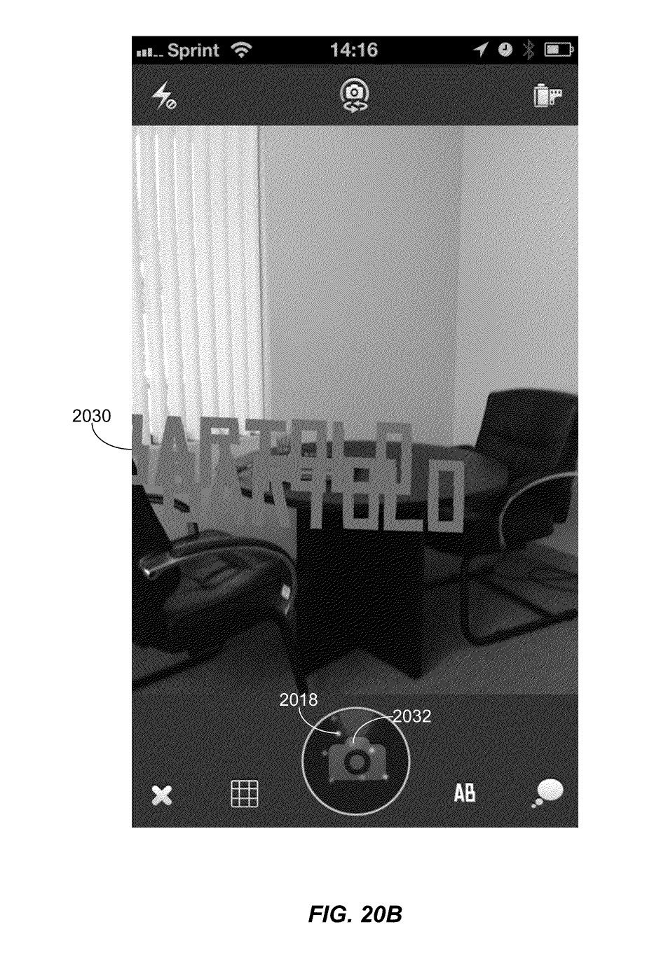

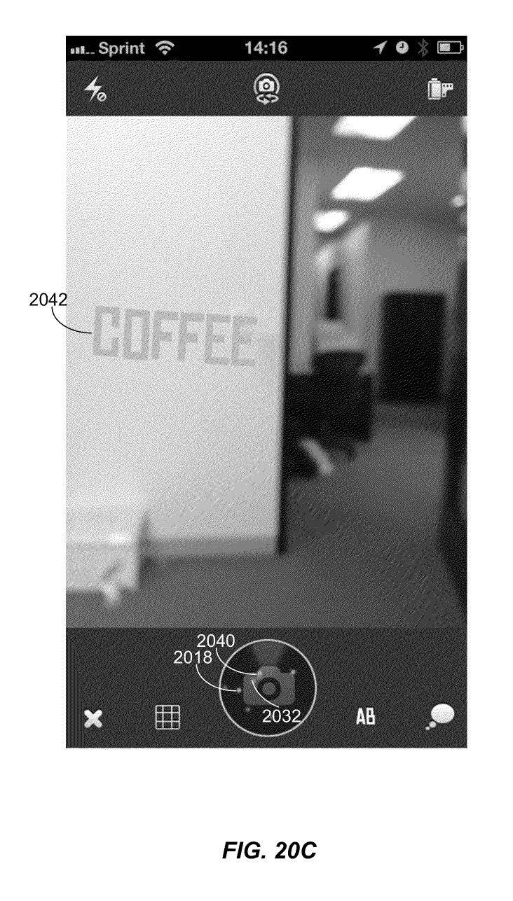

The application software 326 on the client device 102 may also include an augmented reality module 410. The augmented reality module 410 provides an augmented reality view to the user. In some embodiments, the augmented reality view may be provided using the camera lens, allowing the user to view augmented reality on the display 204 based on imagery received by the camera lens. The imagery received by the camera lens may be enhanced with metadata that is associated with the location that is the subject of the focus of the camera lens. For example, much like the mapping interface 406 module above, the augmented reality module 410 may be configured to retrieve thoughts, photographs, and other data associated with the location being viewed through the lens. This retrieved information may be superimposed into the augmented reality view displayed to the user. Detailed examples of this view will be discussed in connection with FIGS. 20A-20C below.

The application software 326 on the client device 102 may further include an image processing module 408. The image processing module 408 may work in conjunction with an image editor 402 to allow the user to apply color image filters on photographs taken using the camera functionality of the client device 102. The image editor 402 may be configured to provide a user interface which allows a user to make modifications and enhancements to images within the software application. In some embodiments, the image editor 402 may allow for image processing to take place on the client device 102, and may further create meta-data which is used to make similar modifications on images stored on the social networking system 106. Additional details about image editing processes performed by the image editor module will be discussed in connection with FIG. 8 below.

The client application software 326 may further include a notification module 412. The notification module 412 is a group of software components configured to monitor events within the social networking system 106, such as user posts, comments, emotional reactions (as indicated, for example, by color coded photographs associated with users), and the like. The notification module 412 will typically accessed data which indicates information and events about which the client device 102 user seeks notification. The notification module 412 will periodically query the database (or alternatively, receive push notifications) to discover any new events which should be brought to the user's attention. The notification module 412 may be configured to provide a specific notifications area within a graphical user interface, which allows a user to easily be made aware of important events taking place within the social networking system 106.

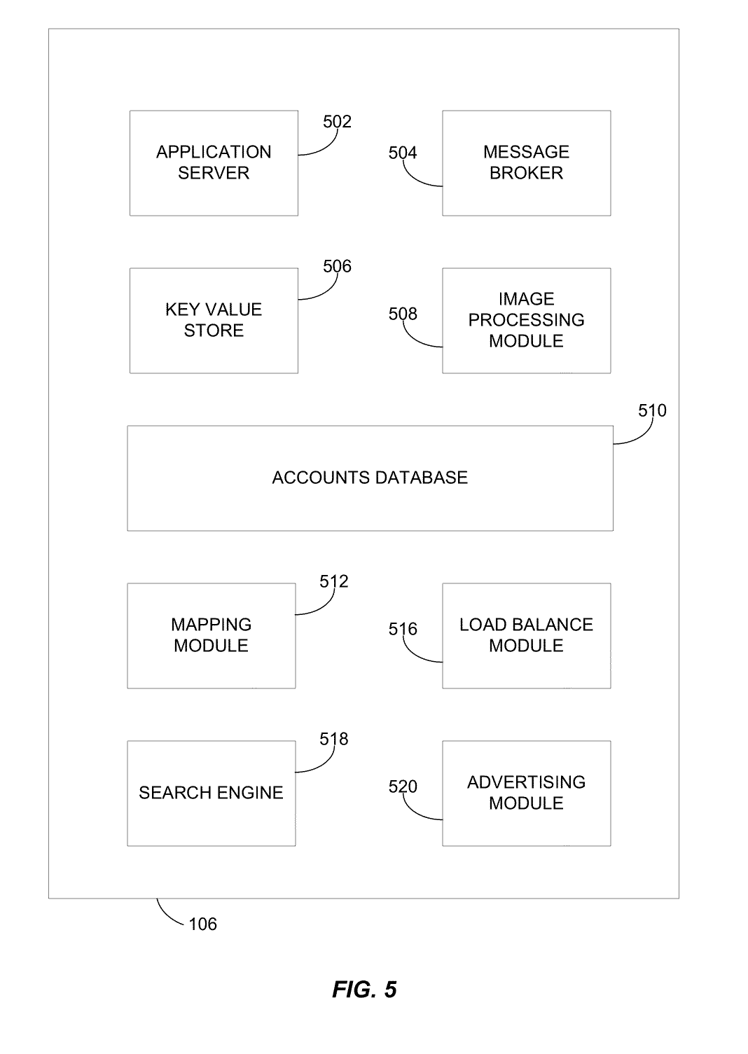

As discussed above, the social networking system 106 may be deployed within a client/server environment. Client devices 102 may access the social networking system 106 via the network, and the social networking system 106 may be deployed in a distributed server environment across one or more computer servers. Turning now to FIG. 5, one example configuration of a social networking system 106 is provided. The social networking system 106 may include an application server 502. The application server 502 may be configured with application software 326 which drives a social networking application within the system. In one embodiment, the application server 502 may be hosted within a Python-based environment. Other application server 502 environments may also be used, including Ruby on Rails environments PHP-based environments, Java-based environments, ASP.net-based environments, and the like.

The social networking system 106 and may also include a message broker 502. The message broker 502 may be used to manage message queues and route messages to their appropriate destinations within the system. The social networking system 106 may also include a key value store 506. The key value store 506 may be used to store application data in a manner known in the art. The social networking system 106 may also include an image processing module 508. The image processing module 508 may be configured to process images much in the same way that images are processed on the client device 102. As will be explained below in connection with FIG. 8, the image processing module 508 on the social networking system 106 may be configured to receive metadata from the client device 102 after image processing has been performed on an image on the client device 102. The server-side image processing module 508 may then perform similar processing in order to provide an efficient way to modify images stored within the social networking system 106.

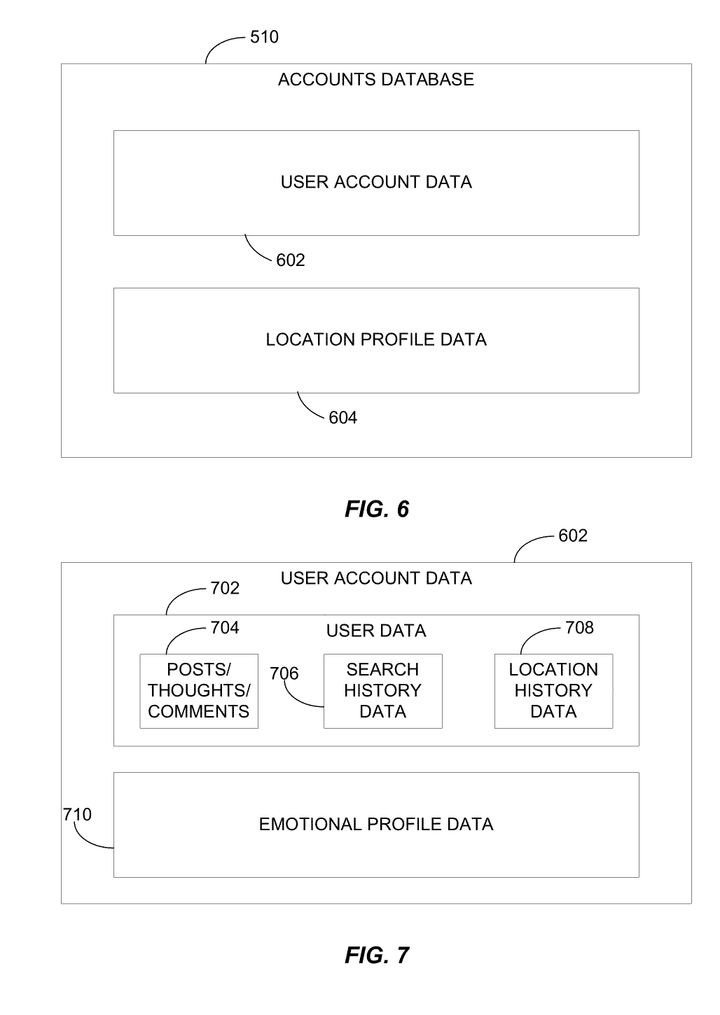

Social networking system 106 may also include and accounts database 510. The accounts database 510 may be a SQL or some other relational database that stores information about user accounts and other related, relevant data. FIG. 6 provides a more detailed view of and accounts database 510 according to one embodiment. As shown, the accounts database 510 include user account data 602 and location profile data 604. The location profile data 604 includes data relating to specific locations which are identified in the accounts database 510. For example, location profile data 604 may include data which indicates the specific emotional sentiment that is prevalent at a particular location such as, for example, a particular restaurant. The location profile data 604 may further include information relating to specific thoughts which are posted at places proximate to the specific locations. This data allows for statistical analysis of specific locations to provide a better understanding of user sentiment and behavior based on specific and targeted locations. Using various statistical analysis methods, targeted information such as advertisements and other types of data may be selected to better fit and emotional profile that is associated with a particular location.

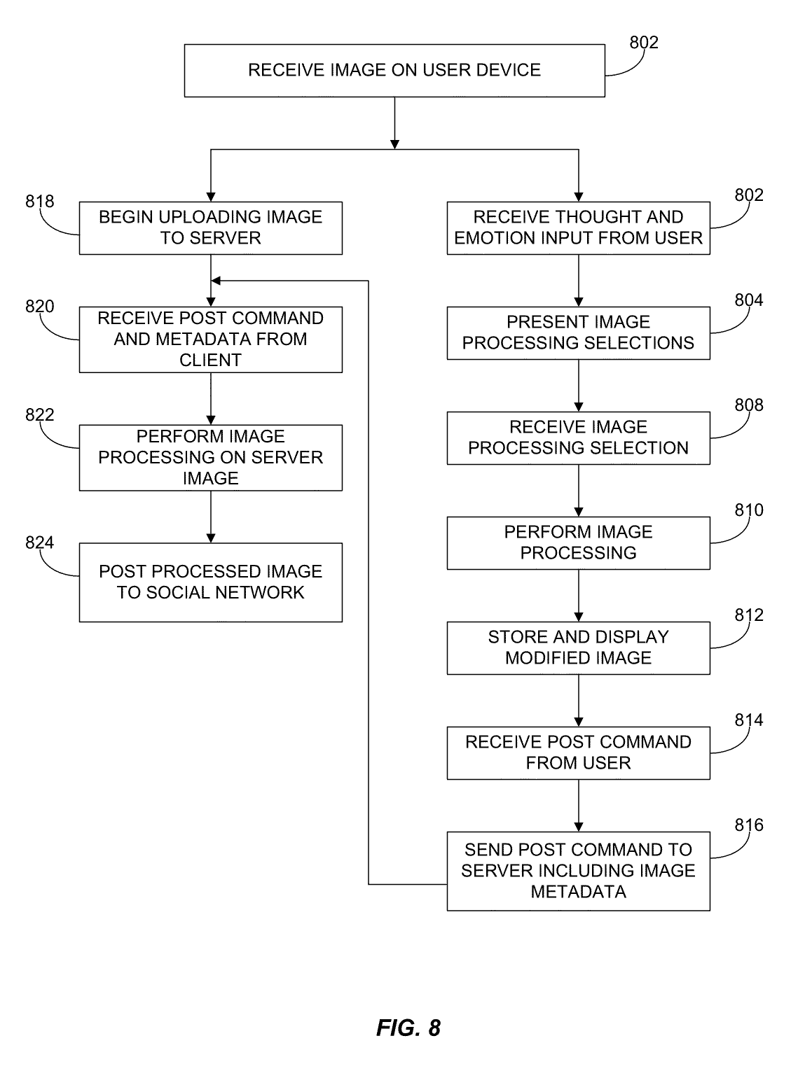

Turning now to FIG. 7, a more detailed view of the user account data 602 from FIG. 6 is provided. As shown, the user account data 602 may include user data. User data 702 includes information relating to specific users who access the system using client devices 102. In certain embodiments, this information may include basic user account information such as a username, a password, and other types of generally user account information. Additionally, user data 702 may include post/though/comment data 704 stored relating to posts, thoughts, comments, and messages made by users of the social network system 106. Also included in the user data 702 may be search history data 706. The search history data 706 may take the form of a database table which itemizes each search made by a user within the system, along with the date and time that search was made. This information may be collectively used in order to determine certain emotional and/or informational trends within the social networking system 106. The user data may also include location history data 708. The location history data 708 generally includes information relating to places that users have posted, commented, and otherwise interacted with the system. This location history data 708 may be gathered by the client device 102 using location sensor in conjunction with the application software 326 stored on the client device 102. For example, when a user posts a photograph and/or a thought to the system, the positioning sensor 302 may assist the client device 102 in determining the location at which the posting occurred and storing that location in the location history data 708, along with date and time information to indicate when that location was visited.

The user account data may also include emotional profile data 710. The emotional profile data 710 may generally include information about emotion entries made by each user which is used to create a profile about the user. For example, the emotional profile data 710 may include an “average” emotion based on user postings, comments, and feels, for determined period of time (i.e. user was mostly happy the month of February). The emotional profile information may further include the most recent emotion inputted by a user. This information may be used to provide real-time information about a specific user's state of mind, and direct communications to that user is appropriate to that state of mind. The graphical interface may also adjust itself to accommodate the user's current state of mind (e.g., showing yellow interface elements when the user is happy, or blue interface elements when the user is sad). Emotional profile data 710 may further include an average or most popular emotion entry given to a specific content or location. As can be appreciated, this information may be useful for measuring emotional sentiment both on a macro level, and on a user by user level. In some embodiments, the emotional profile data 710 may track the average emotion in a relationship between the two users. This aspect of emotional profile data 710 may be determined by interaction between two users, for example, the average emotions used in messages or comments exchanged between those two users. This type of emotional profile data 710 may be used to provide insight into the nature of the relationship between the two users. For example, two users who post a “Love” emotion in connection with their messages to each other, are more likely to have an emotional and/or amorous relationship between them. Other types of emotional profile data 710 may also be collected in the social networking system 106. The examples above are intended to provide illustrations of possible types of emotional profile data 710, but are not intended in any way to be limiting.

Turning back to FIG. 5, the social network system 106 may also include a mapping module 512. The mapping module 512 is generally cast with maintaining a maps database, along with associating metadata with user activity taking place at specific locations. The mapping module 512 may be further configured to collect location history data and location profile data from the accounts database 510 in order to generate map information which includes information about predominant and/or prevalent emotional sentiments in a specified geographic area. For example, the mapping module 512 may be configured to show the most popular emotion and/or thought in each continent in the world. The information may also be presented in a much more granular fashion by the mapping module 512, as it may focus on a popular emotion in a specific city, ZIP Code, or even neighborhood.

In certain embodiments, the social networking system 106 also include a load balance module 516. As is known in the art, the load balance module 516 may be used to direct user requests to one or more application servers 502 which are used in the system. Depending on the volume of traffic at any given time, more than one application server 502 may be required to handle system requests. The load balance module 516 enables the social networking system 106 to efficiently and quickly accommodate those requests.

The social networking system 106 may further include a search engine. The search engine is typically configured to index relevant subject matter, such as posts, locations, thoughts, feelings, and the like so that they can be quickly located and presented within results to searches submitted by users. An advertising module may also be provided in the social networking system 106. The advertising module, which is discussed in more detail below, may be configured to deliver contextually relevant advertisements to users based on various factors.

As previously mentioned, embodiments of the invention provide systems and methods which allow for users to easily capture images using client devices 102, and to post those images to the social networking system 106 after providing user-selected edits and processing on the images. More specifically, embodiments of the invention allow the user to capture an image using the camera on the client device 102, input a thought and/or emotion, process the image, and then post the image for others on the social networking system 106 to see.

FIG. 8 provides an example of a process for capturing an image and posting it to the social networking system 106, according to one or more embodiments of the invention. The process begins at block 800, the client device 102 receives an image captured using the camera on the client device 102. The image may be a photographic image taken using the camera functionality of the device. In some embodiments, the image may be taken in an augmented reality mode of the device, and the captured image may include augmented reality data delivered into the augmented reality view displayed to the user of the device.

Next the process moves to block 802, where, having captured the photographic image, the client device 102 then receives a thought and/or an emotional input from the user. Next, the process moves to block 804, were image processing selections are presented to the user. At block 806, the user selects one or more of the image processing selections made available. These selections create image metadata which will be provided to the server. Next, the process moves to block 810, where the client device 102 performs image processing on the captured image according to the image processing selections made by the user. Once the image processing has been performed, the client device 102 and stores and displays the modified image on the device display 204 at block 812. Then, at block 814, the user can review the image and if satisfied, can input a post command which indicates that the image should be posted to the server. Once the post command has been inputted by the user, the process moves to block 816, with the client device 102 sends the post command to the server including the image metadata inputted by the user.

In parallel to the user performing image processing selections on the client device 102, the client device 102 also begins uploading the initially captured image to the server at block 818. It does so, in order to speed the process of providing the finished image to the server, and to give the user a sense of an instantaneous upload of the fully processed image. After the originally captured image begins uploading to the server, the post command may be received by the server as shown in the flowchart, and the process moves to block 820. There, the server receives the post command and the metadata from the client device 102. Because the metadata is the same metadata used for the image processing performed on the client device 102, the server is able to perform the same image processing on the image. Thus, with the post command in the metadata in hand, the process moves to block 822 where image processing is performed on the received image. Once the image processing has completed on the server, the image on the server will look the same as the processed image stored on the client device 102. The process then will move to block 824, where the social networking system 106 posts the processed image to the social network.

As discussed above, by performing the image processing on both the client and the server in parallel, the system need not wait until the image processing selections are made on the client before it begins uploading the image to the server. Thus, while the user is making image processing selections on the client, the server is already in the process of receiving the large image file via the network.

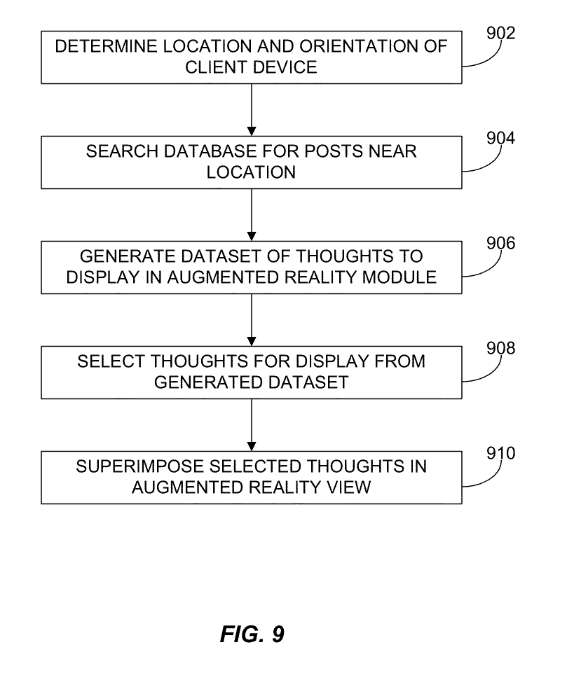

As discussed above, in certain embodiments, the social networking system 106 allows the user to view information shared by other users in the social network within an augmented reality view. FIG. 9 is a flowchart which provides one example process by which this may occur. The process begins at block 902, where the location and orientation of the client device 102 is determined. This determination may be made using the positioning sensor and/or the motion sensor on the client device 102. Next, the process moves to block 904, where the client device 102 makes a request to search the database for posts made in the social networking application which are relevant to the current location of the user. Typically, these posts will include images and/or thoughts posted by other users in the same location, but they may also include images and/or thoughts previously posted by the requesting user at that location. Next, the process moves to block 906, where the social networking system 106 generates a data set of information to display 204 in the augmented reality module 410 on the client device 102. The process then moves to block 908, where one or more thoughts from the generated data set are selected for display 204 on the client device 102 this election may be made based on various factors, including but not limited to, the proximity of the thoughts to the current location of the user, the temporal proximity of the thoughts to the current time, the popularity of the posts related to those thoughts, or some other factors. Next, the process moves to block 910. There, the selected thoughts are superimposed into the augmented reality view presented on the display 204 of the client device 102. (An example of this augmented reality view is provided in FIGS. 20A-20C.)

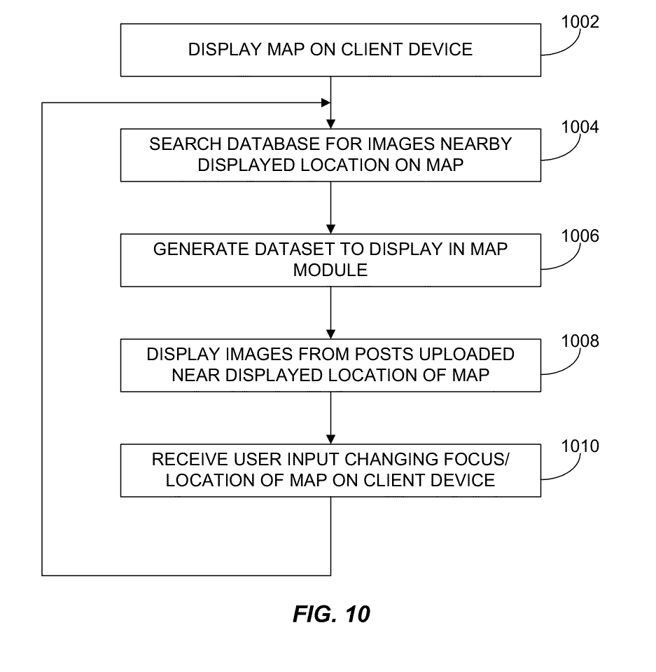

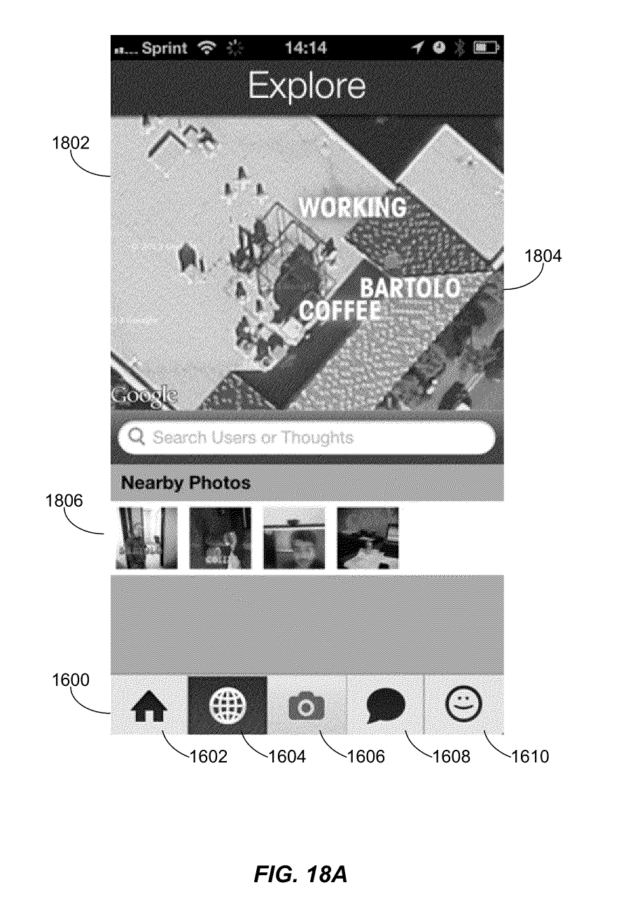

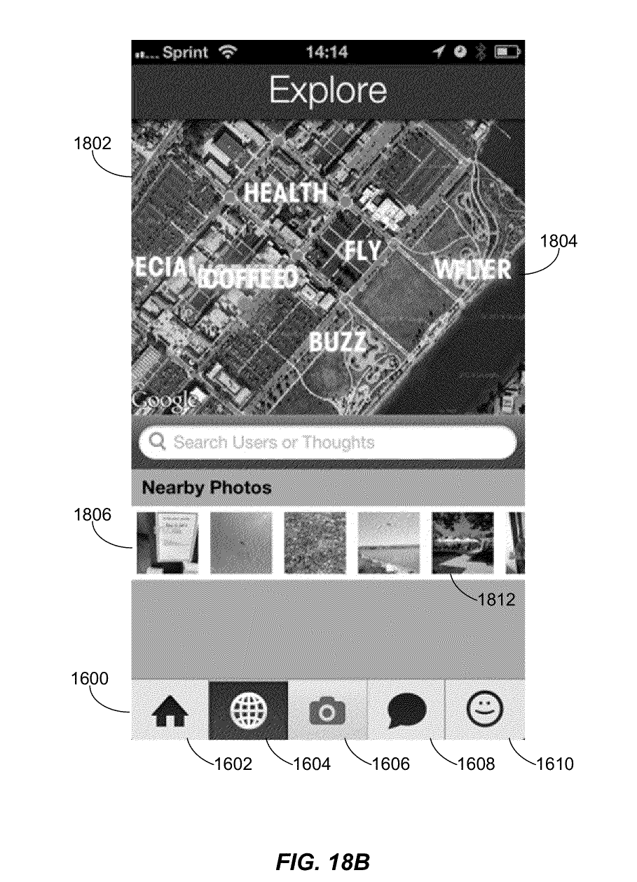

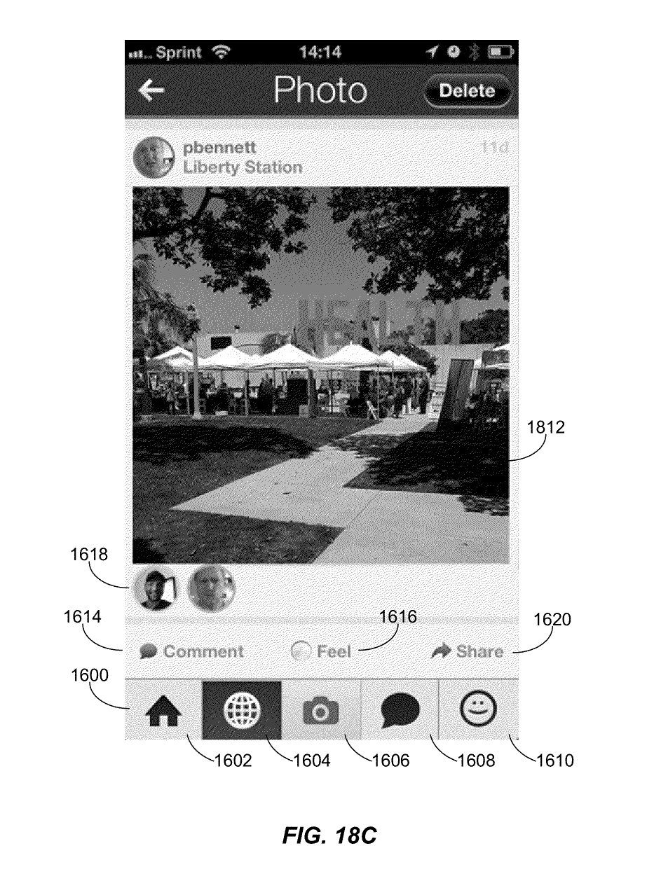

In addition to displaying thoughts within an augmented reality module 410 on the client device 102, in certain embodiments, thoughts may also be displayed within a map view on a client device 102, as shown in FIGS. 18A-18B. FIG. 10 is a flowchart illustrating a process by which these thoughts may be selected and displayed in a map view. Process begins at block 1002, where using the mapping module 512, a map is displayed on the client device 102. Typically, the map will initially display 204 the area surrounding the current location of the device. However, the user may adjust that location as the user deems appropriate. Once the map is displayed on the client device 102, the process moves to block 1004, where the system searches the database for images captured in locations near the currently displayed location on the map. Next, the process moves to block 1006, where a data set of images is generated based on the database search. The process then moves to block 1008, where the images in the data set are displayed to the user. As noted above, these images may be photographic images captured by other social network system 106 users near the current location of the device. A skilled artisan will appreciate that other data may also be presented with the map, such as thoughts posted by other users in the vicinity of the client device 102.

In some embodiments, the client device 102 and/or system may be configured to adjust the displayed images based on user inputs which change the location or zoom-level of the map. For example, if the user zooms the map out to cover a large geographic area, the displayed images may no longer be the most relevant to the area displayed on the map. Thus, when the client device 102 or social networking system 106 receives a user input which modifies the location or focus of the map (as shown in block 1010), the system may return to block 1004 and begin the search process again to retrieve new results based on recentness, relevancy, and/or popularity for display 204 on the map. Thus, the map module may be configured to automatically, and in substantially real-time, update the thoughts and images displayed to the user when the map view is modified by the user.

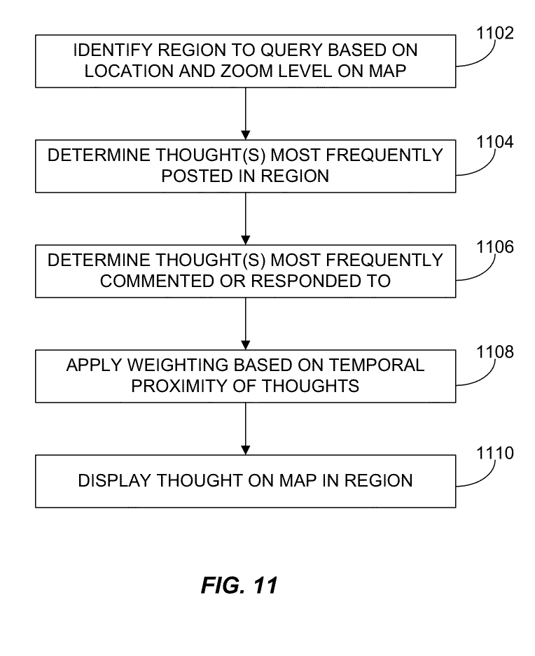

In some embodiments, the map view may be configured to display 204 thoughts which are superimposed on the map. An example of this functionality is shown in FIG. 18A and 18B, which will be discussed in additional detail below. FIG. 11 is a flowchart which illustrates one process by which thoughts may be displayed on a map in the map view. The process begins at block 1102, where the geographic region to query for thoughts is determined based on the location and zoom level on the map. Next, the process moves to block 1104, where the system determines which thought or thoughts have been most frequently posted in the region identified in block 1102. From there, the process moves to block 1106. There, the system also identifies the thought or thoughts most frequently commented on or responded to by other social network users. Next, the process moves to block 1108, where the various identified thoughts are weighted according to their temporal proximity, with more recent activity given more weight than less recent activity. Based on the applied weighting, one or more thoughts may be posted on the map in the specific region.

A skilled artisan will appreciate that using the process described in the FIG. 11 above, the most popular thought for a specific region can be displayed on a map to the user. In some embodiments, the map may be displayed in such a way as to show the most popular thoughts and/or emotional sentiments in several specific regions at the same time. For example, the map may show the most popular thought or emotion on each continent (e.g., Europe, South America, North America, Asia, Africa, etc.). This can provide a highly-detailed statistical analysis in real time of the current sentiments or ideas of a certain location (e.g., a country undergoing a revolution which is colored purple with the sentiment Angry, and which contains the most popular thought of “Freedom”).

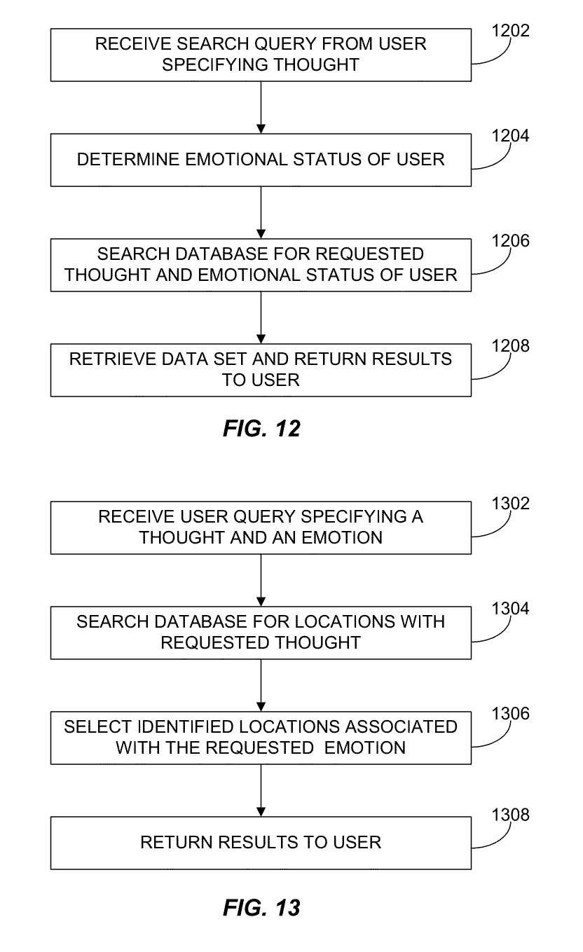

As discussed above, the social networking system 106 may include a search engine module which may be used to search for information within the social networking system 106 based on attributes specified by, and specific to, the user. FIG. 12 is a flowchart which illustrates one example of how search functionality in the search engine module may be tied to emotional sentiment according to one or more embodiments.

The process begins at block 1202, where a search query is received from the client device 102 of a user. In this particular example, the search may be for a specific thought posted by other users. In other embodiments, the search query may be directed to some other type of information such as a location or a person. Upon receiving the query, the search engine module may determine the emotional status of the querying user by retrieving that information from the user account data at block 1204. Next, the process moves to block 1206, where a search is executed which seeks information based on the requested information and the emotional status of the user. For example, if the user searches for the thought “Freedom” and the user's current emotional sentiment is “Happy”, the system may return thoughts posted having the word “Freedom” in connection with a “Happy” emotion. Once the data search is complete, the relevant results are retrieved and returned to the user at block 1208.

In the example provided in FIG. 12, the search engine module is configured to return search results which take into account the current emotional state of the user submitting the search engine query. In some embodiments, the search engine module may also be configured to allow the user to specify a particular emotion, irrespective of their own emotional state. For example, the user may submit a search for content which specifies both the content (such as a specific thought, for example), as well as an emotion. For example, the user may submit a query for “Beer” and “Happy.” In response, the search engine module may return the nearest location or locations at which the “Beer” thought was posted and the “Happy” emotion was associated with the post.

FIG. 13 provides an illustration of a process for conducting a search for locations based on both a specified thought and a user-specified emotion. The process begins at block 1302, where the social network system 106 receives a user query which specifies both a thought and an emotion. Next, the process moves to block 1304, wherein the database is searched for locations at which the specified thought was posted. Once those locations have been identified, the process moves to block 1306, where the search engine module then narrows the results by selecting the identified locations associated with the requested emotion. Next, at block 1308, the results are returned to the user on their client device 102.

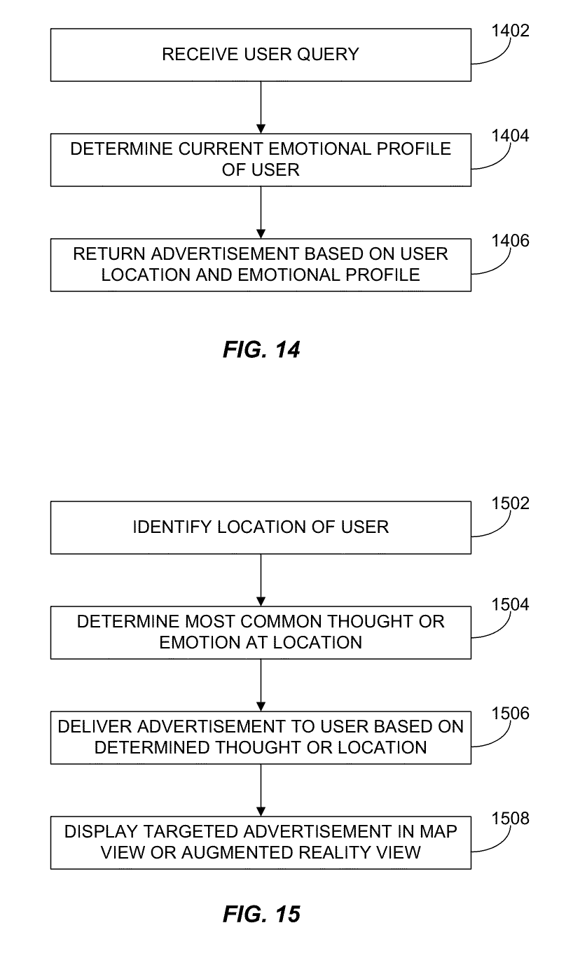

As was discussed above, the social networking system 106 may also include an advertising module which is configured to deliver advertisements to users based at least in part on information stored in the social networking system 106 relating to the user. In certain embodiments, the advertising module may be configured to deliver advertisements in response to search engine queries made within the system which are based on one or more aspects of their the submitting user's emotional profile. FIG. 14 is a flowchart which illustrates one example process by which these advertisements may be delivered to users.

The process begins at block 1402, where the social networking system 106 receives the query submitted by the user. Having received the query, the process that moves to block 1404, where the system determines the current emotional profile of the user who submitted the query. Next, the process moves to block 1406. There, an advertisement is selected based on the current location of the user submitting the query, as well as the emotional profile of the user. Foss advertisements may be directed to users based on their emotional sentiment.

In some embodiments, the system may be configured to deliver and inject advertisements directly onto a map view or an augmented reality view presented to a user on a client device 102. In some embodiments, these advertisements may be based on the thoughts and or emotions which are the most common at the specific location of the user. For example, if the user is in a location where the most common thought is “pizza”, the advertising module may be configured to display 204 an advertisement for a local pizza restaurant in the map view or the augmented reality view. FIG. 15 provides an illustration of one technique for delivering these types of advertisements. The process begins at block 1502, where the social networking system 106 identifies the location of the user. The process then moves to block 1504. There, the system queries the database to determine the most common thought and/or emotion that has been posted at that particular location. Next, the process moves to block 1506, where the system delivers an advertisement to the client device 102 which is selected based on the determined thought and/or emotion. At block 1508, the advertisement is displayed in the map view or the augmented reality view to the user.

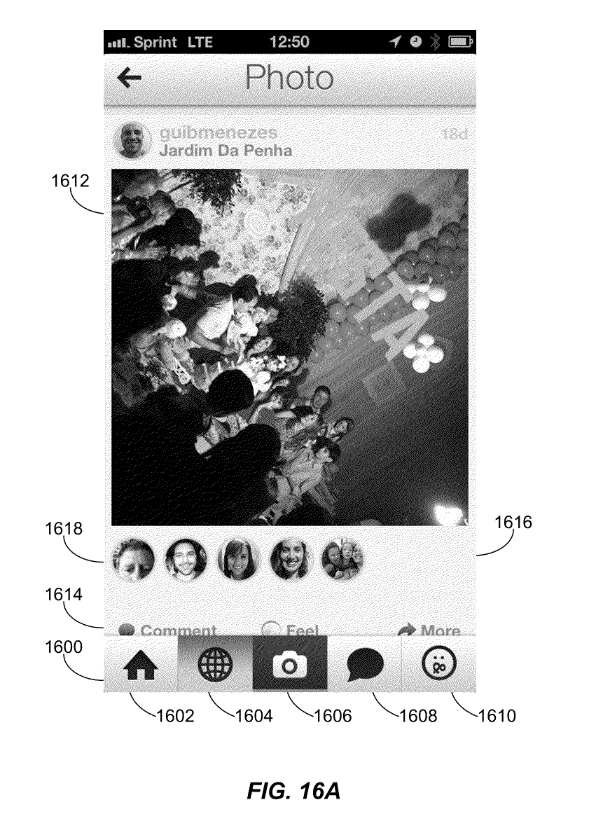

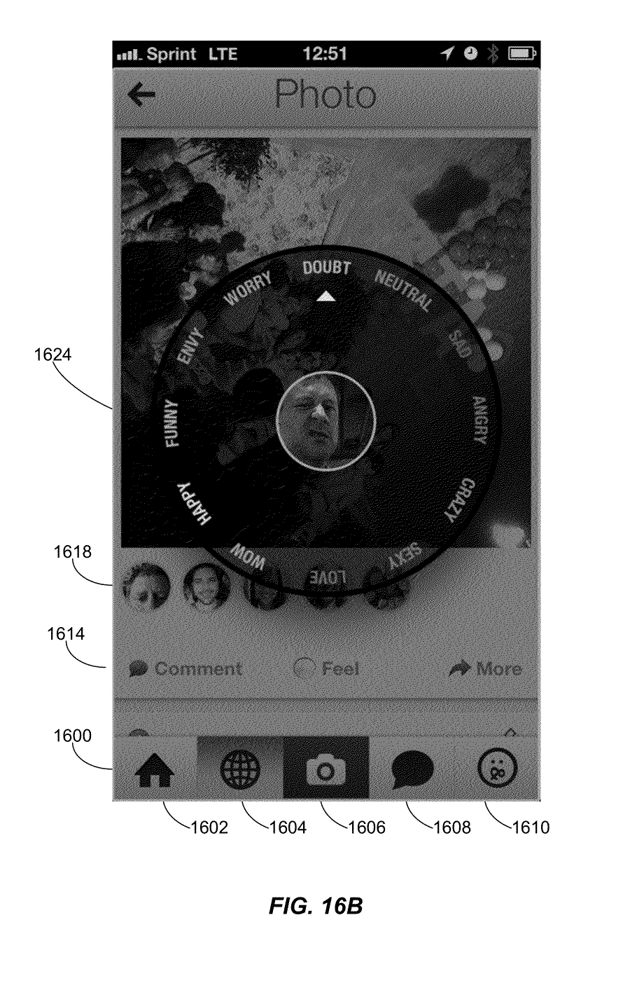

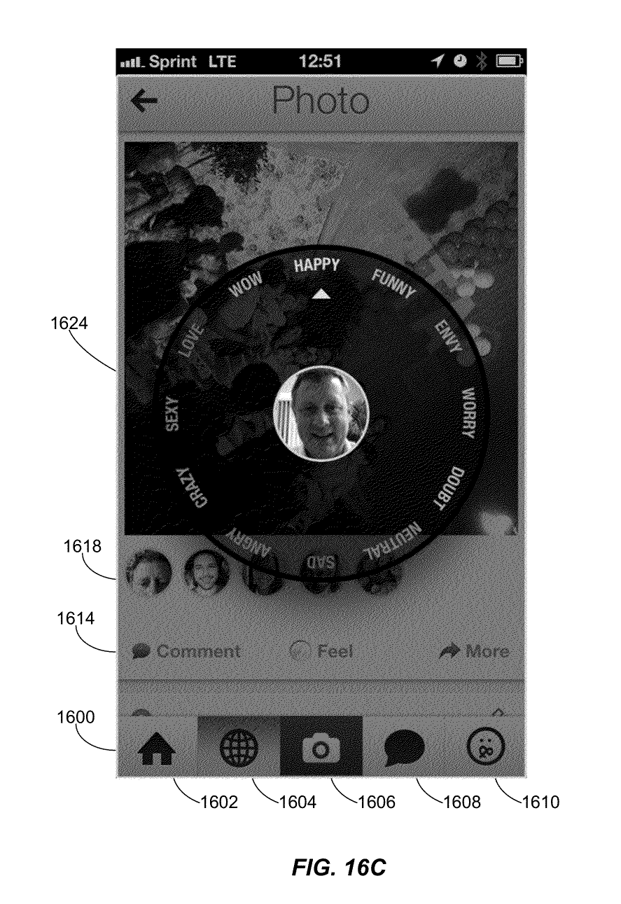

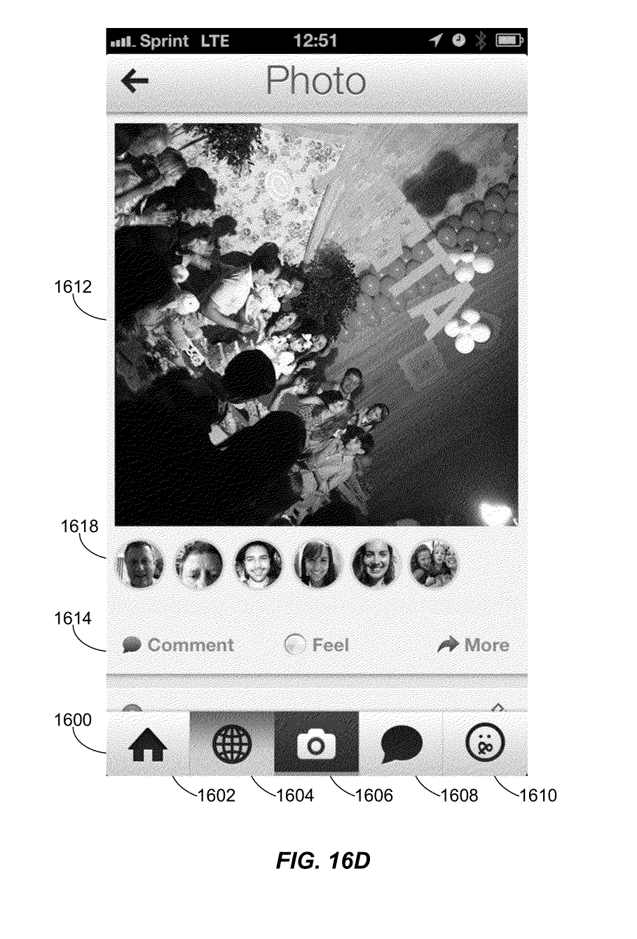

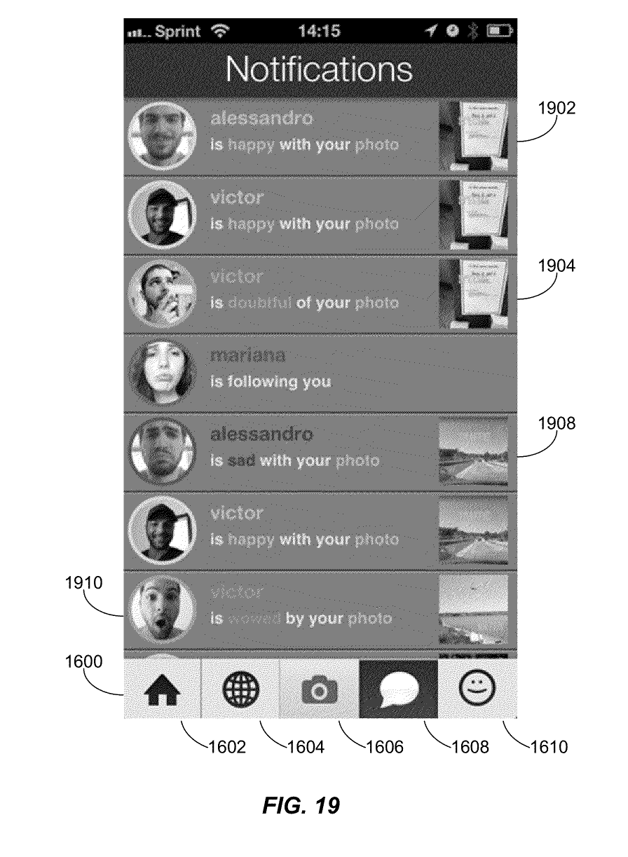

FIG. 16-20 provide illustrations of graphical user interfaces which may be used to implement many of the processes described above on a client device 102. FIGS. 16A-16D are examples of a user's “news” feed which may be delivered to a client device 102 according to one or more embodiments. As shown, the news feed shows a post made by another user of the social network which appears on the display 204 associated with the user. Also shown in the figure is the menu/navigation bar 1600. The menu/navigation bar 1600 includes several tabs which may be selected by the user to navigate within the application. These tabs include a home tab 1602. The home tab 1602 brings the user to their newsfeed. Which is shown above, and will be discussed in more detail below. The menu/navigation bar 1600 also includes a map tab 1604. Selecting the map tab 1604 activates the map module on the client device 102. The map module will be discussed in additional detail below in connection with FIG. 18. The menu/navigation bar 1600 also includes a camera tab 1606. The camera tab 1606 is used to activate the augmented reality view within the application. Additional details regarding the augmented reality view will be discussed in connection with FIG. 20 below. Also included in the menu/navigation bar 1600 is a notification tab 1608. The notification tab brings the user to the notifications interface. The notifications interface will be discussed below in connection with FIG. 19. Lastly, the menu/interface bar may also include a profile tab 1610. The profile tab provides access to the profile management interface within the application.

FIG. 16 also shows an example of a post which appears in the newsfeed of a client device 102. The post includes various pieces of information. In this particular example the post includes a photograph 1612. Included within the photograph is a thought 1613. In this instance the thought is “FESTA”. In some embodiments, the text on the photographs is clickable. Because the server “replicates” the text rendering on the local device (see, e.g., FIG. 8), the server knows the position, size and metadata of the text on the photograph being displayed on the device. This knowledge allows the text to be interactive. Thus, a user can click on the text “FESTA” and see other content posted with this thought. Similarly, if the thought is the in form of a user address, such as “@alessandro” for example, clicking on the thought may send the user directly to the profile page associated with that user address.

The newsfeed interface also allows for a user to comment on the post by selecting a comment interface element 1614. Similarly, the user can express an emotional sentiment that is evoked by the post, by selecting the “feel” user interface element 1616. In this particular example, for different users have selected the “feel” user interface element 1616. Each of these users are displayed above as circular photographs 1618. In some embodiments, these photographs will have specific colors associated with them. The colors may provide an indication of the emotional sentiment of the person who has provided the emotional feedback.

Turning to FIG. 16B, an example user interface is provided which shows how a user can provide emotional feedback to a post. This particular example, the user has selected the “feel” user interface element 1616. Doing so brings up the wheel interface 1624 shown in the figure. The user may rotate the wheel in order to select and emotional sentiment to express with respect to the post. In FIG. 16B, the “Doubt” emotion is selected, which displays a corresponding photograph of the user. Turning now to FIG. 16C, the wheel interface 1624 has been rotated to the “Happy” emotion. The user can select the happy emotion by touching the photograph in the center of the circle. Doing so will cause that photograph to appear as a circular photograph 1618 below the post 1612, as shown in FIG. 16D. Thus, in certain embodiments, users are able to express a broad range of emotional sentiment regarding content posted by other users.

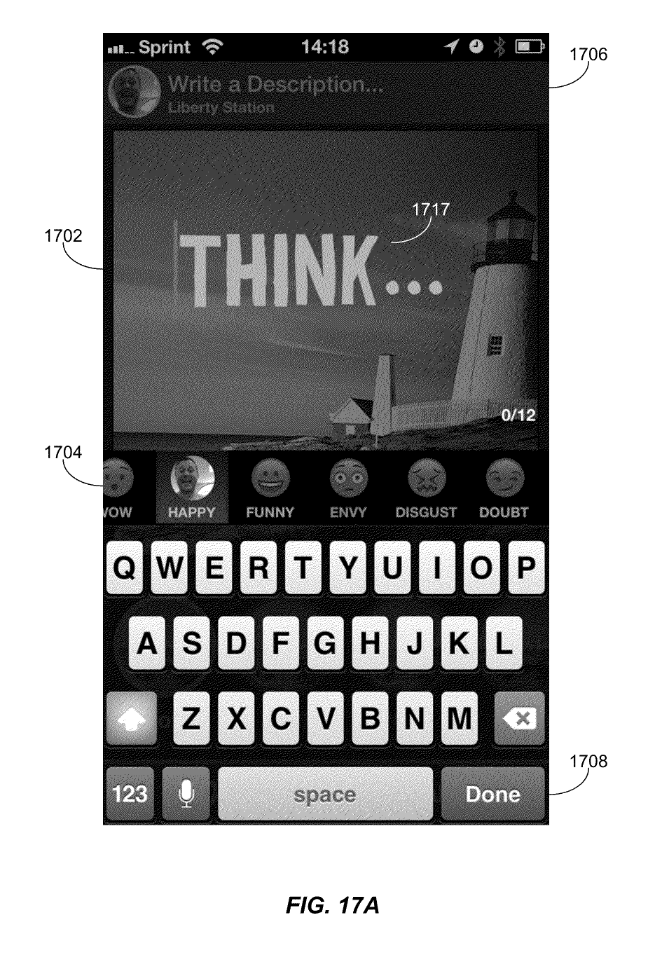

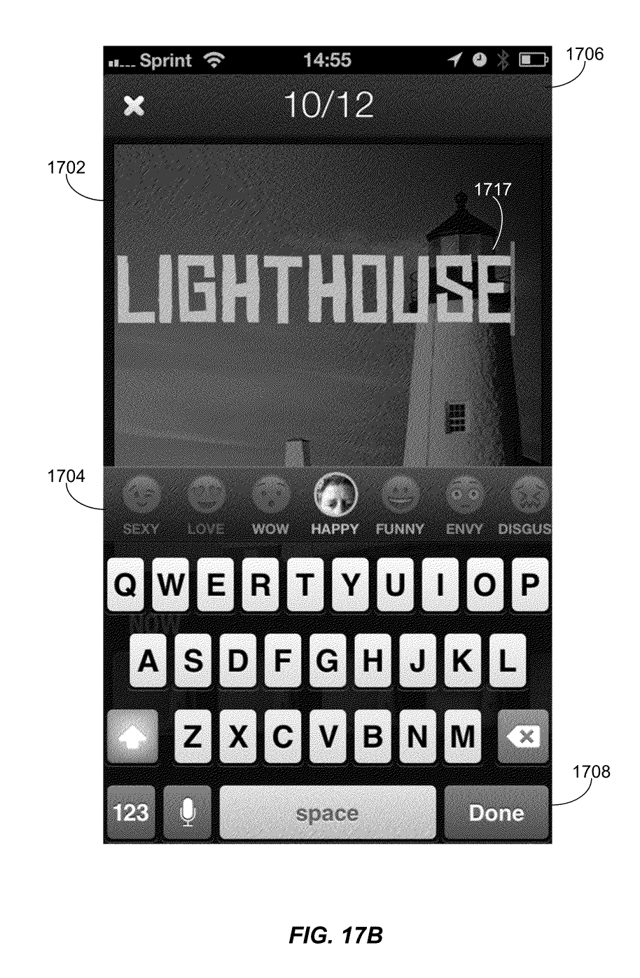

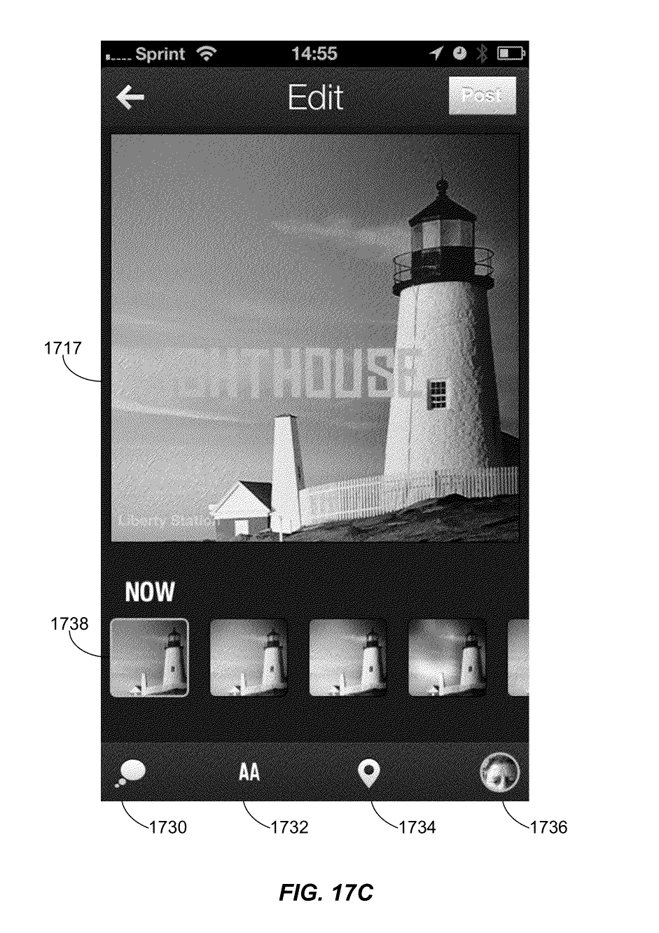

As discussed above, the social networking system 106 also allows users to post content, an associate that contents with an emotional sentiment. FIG. 17A-17C are examples of user interfaces which may be used to post a visual thought within the social networking system 106 according to one or more embodiments. As shown, the user has taken a photograph of a lighthouse. The photograph 1702 is displayed on the screen along with a word 1717. The user is invited to type a new word to replace “Think . . . ”. This new word can be considered a thought that will be associated with the post. In addition, the user was also asked to associate an emotion with the post as well. The available motions are provided in the scrollable list 1704 which appears below the photograph. A selection may be made from that list and when it has been made, the user may select the done key 1708 in order to complete the post.

Turning now to FIG. 17B, the user has typed a new word 1717 as a thought to include with the photograph 1702. In this case, the user has typed the word “LIGHTHOUSE”. In addition, the user has selected the “Happy” emotion from the scrollable list 1704. In certain embodiments, the user is also able to perform image processing on the photograph. As shown in FIG. 17C, once the user has selected the done key 1708 from the keyboard in FIG. 17B, the image processing interface of the application is provided to the user. As shown, the user is provided with several different options for editing the photograph. For example, the user may select a color scheme 1738 for the photograph, a location for the photograph 1734, a font for the thought superimposed on the photograph by selecting interface element 1732, or a different emotional sentiment to tie to the photograph by selecting interface element 1736. Once the user has made each of the selections, they may post the photograph to the social networking system 106 by selecting the post button on the interface. As can be appreciated, this user interface can be used in conjunction with the process described above in connection with FIG. 8.

As discussed previously, in certain embodiments, the social networking system 106 may provide client devices 102 with a map view that provides information superimposed on the map related to prior activity within the social network which has taken place in the specific location on the map. FIGS. 18A-18C are examples of user interfaces which provide information regarding thoughts and emotional sentiments expressed in a specified location displayed on a map. As shown, the user interface is in the map view. Turning to FIG. 18A, the map view 1802 is shown. Within the map view 1802, are the various thoughts which were posted by users in the vicinity of the area shown in the map. Thus, the thought “working”, the thought “Bartolo”, and the thought “coffee”, were each posted near the location shown in the map. In some embodiments, these thoughts are obtained from the database using the process described in connection with FIG. 11 above. The interface also shows photos 1806 which were taken nearby the location shown in the map and posted to the social networking system 106.

As discussed above, certain embodiments allow for the displayed images to change based on modifications made to the focus and/or location of the map displayed on the client device 102. This particular process flow was discussed in connection with FIG. 10 above. The transition from FIG. 18A to FIG. 18B provides a visual example of this functionality. In FIG. 18A, the zoom level of the map is very close, and covers only a small area. When the user broadens the zoom level, as shown in FIG. 18B, the system queries the database for additional photos and thoughts which are near the new, larger area displayed in the map. Thus, additional thoughts 1804 and photos 1806 are shown. If the photos 1806 are of interest to the user, they may select one of them to see the details of the post related to that particular photograph. Turning now to FIG. 18C, an example is shown of the user interface presented when the user selects the photograph 1812 from FIG. 18B. As shown, the user interface goes to the post which includes photograph 1812 and its associated thought “HEALTH”, as well as the emotional sentiment values 1618 associated with that post. Thus, using the map interface, a user is able to easily access content of interest to them that was posted by users in specific locations.

FIG. 19 is an example of a user interface for providing notifications to a user of the social networking system 106. As shown, the notifications interface 1900 includes a list of notifications regarding content posted to the social networking system 106. The notifications may include notifications regarding emotional sentiment expressed by other users about posted content. Examples of these types of notifications are shown as notifications 1902, 1904, and 1908, which relate to photographs posted by the user. In order to enhance the ability for users to express share emotional sentiment, each notification includes an image (such as image 1910, for example) which is also indicative of the emotional status of the user associated with the notification.

As discussed above in connection with FIG. 9, embodiments of the invention allow for content posted in the social networking system 106 to be superimposed into an augmented reality view based on the location and time that at which it was posted. FIGS. 20A-20C are examples of a user interface which superimposes posted thoughts within an augmented reality view according to one or more embodiments. Turning to FIG. 20A, an augmented reality view interface 2000 is shown. The augmented reality view includes an augmented reality view toolbar 2004 having several toolbar elements and an augmented reality video image 2002. Included in the toolbar elements is a thought-map 2006. The thought map 2006 is a visual element that shows, relative to the current point of view of the camera on the client device 102, the other thoughts that have been posted by users in that specific area. The thought map 2006 includes current point of view indicator 2016, which, in this case, is a slightly illuminated area on the thought map. The current point of view indicator 2016 shows the area that is currently within the displayed point of view.

In the example shown in FIG. 20A, the current point of view indicator 2016 shows that there is a single thought within the current point of view of the device, as indicated by a white dot in the view indicator. As is to be expected, because the current point of view indicator 2016 indicates that there is one thought in the current point of view, there indeed is a thought 2014 that is superimposed on the augmented reality video image 2002. In some embodiments, the thought is presented with animation which gives it the appearance of floating in the air. Other visual enhancements may also be used. In some embodiments, the thought 2014 may be interactive in the same way that the thoughts displayed on photographs, as discussed above in connection with FIG. 16.

As the point of view is adjusted, the thought 2014 will move within the screen, as the thought 2014 is in a fixed position. A high degree of practicality and simplicity is achieved by combining both the button for taking a photograph and the radar for displaying augmented reality content in one graphical element.

Turning back to the thought map 2006, various white dots are present outside of the current point of view indicator 2016. These dots indicate the presence of other thoughts in the immediate area, but which are not in the current point of the view the camera on the camera on the device. Thus, if the user turns the camera, thereby changing the point of view, other thoughts indicated on the thought map will move into the current point of view indicator 2016.

FIG. 20B provides an example of such movement. As shown, the camera view from FIG. 20A has been turned approximately 50-70 degrees to the right. As a result, two new thoughts 2030 appear in the augmented reality video image 2002. Also, the current point of view indicator 2016 now includes a different dot 2032, which indicates that the thoughts 2030 are within the current view of the camera. The dot 2018 which was previously within the current point of view indicator is moved to the left of the current point of view. In some embodiments, the dots may be color-coded to be indicative of the emotional sentiment associated with the thought they represent.

FIG. 20C shows the point of view adjusted an additional 60 degrees to the right. As shown, the dots 2032 and 2018 have moved further around the thought map, and a new thought 2042 has appeared within the view 2002. A new dot 2042 also appears in the current view indicator 2006. Thus, using the augmented reality interface, a user may explore their environment to obtain information about thoughts and emotions other users have previously had at the same location. This type of information allows users to feel more connected to the world around them.

Those of skill will recognize that aspects of the social network system and its various functions described herein may be embodied in one or more executable software modules that may be stored on any type of non-transitory computer storage medium or system, and that some or all of the functions may alternatively be embodied in application-specific circuitry. The various illustrative logical blocks, modules, and algorithm steps described in connection with the embodiments disclosed herein may be implemented as electronic hardware, computer software, or combinations of both.

While the above detailed description has shown, described, and pointed out novel features of the invention as applied to various embodiments, it will be understood that various omissions, substitutions, and changes in the form and details may be made by those skilled in the art without departing from the spirit of the invention. As will be recognized, some embodiments of the present invention may not provide all of the features and benefits set forth herein, and some features may be used or practiced separately from others. The scope of the invention is indicated by the appended claims rather than by the foregoing description. All changes which come within the meaning and range of equivalency of the claims are to be embraced within their scope.

What is claimed is:

1. An augmented reality social network system, comprising:
an accounts database having user account data associated with one or more users, the user account data comprising post data, thought data, location data, and emotional profile data;
an application server configured to:
receive image data, location information, an emotional sentiment value, and a thought message from a client device associated with one of the users, wherein the image data comprises image metadata;
post the image data, location information, emotional sentiment value, and thought message to a social network system account associated with the user; and
modify the user account data based on the posted data;
an image processing module configured to:
process the received image data by superimposing, based on the image metadata, the received thought message over the image data; and
store the processed, received image data in the accounts database;
a mapping module configured to:
receive a request from a client device for information relating to a location on a map;
search the accounts database for thought messages and emotional sentiment values associated with the location on the map;
identify thought messages and emotional sentiment values associated with the location; and
transmit map information and the identified thought message and emotional sentiment values for display within the transmitted map information.
